(19) United States
(12) Patent Application Publication
(10) Pub. No.: US 2006/0106578 A1
(43) Pub. Date: May 18, 2006

(54) Machine management device, communication line diagnosis device and machine management method

(76) Inventors: Tsutomu Yamada, Hitachinaka (JP); Hiromichi Endoh, Hitachi (JP); Koji Masui, Hitachi (JP); Takashi Umehara, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/273,072

(22) Filed: Nov. 15, 2005

(30) Foreign Application Priority Data
Nov. 15, 2004 (JP) 2004-329936

(51) Int. Cl. G21C 17/00

(52) U.S. Cl. 702/183

(57) ABSTRACT

In a computer system, a device for and a method of conducting self-diagnosis of failure such as a break and a short circuit of a data communication line remove difficulty of conducting the self-diagnosis of the break and the short circuit only by driving and monitoring the data communication line by itself. For this purpose, a diagnosis module receives information necessary for self-diagnosis from a monitoring module connected to the data communication line. The diagnosis module to conduct self-diagnosis is connected via a diagnosis communication line to the monitoring module to communicate diagnosis information between the modules.

### BACKGROUND OF THE INVENTION

The present invention relates to a machine management device, a communication line diagnosis device, and a machine management method.

In complex control systems such as a chemical plant and a gas plant, there have been introduced measures in which various risks are qualitatively and quantitatively evaluated to reduce influences upon operators and environment of the systems even at any accident. Heretofore, such safety function has been realized using an electromagnetic relay and a mechanical safety device. However, due to advance and development of computer control techniques in recent years, it has been increasingly needed to use a programmable electronic device as part of the safety device. To cope with this circumstance, namely, to use an electrical/electronic/programmable electronic device as a safety device, International Electrotechnical Commission (IEC) Standard 61508 (corresponding to JIS C0508) has been published.

IEC61508 stipulates a procedure of development, designing, installation, maintenance, and disposal of the electrical, electronic, programmable electronic devices used as safety devices. It is required for the safety device serving a safety function to reduce risks in systems such as a plant in which the device is installed. Therefore, it is essential to quantitatively obtain risks associated with the safety device. For the electrical, electronic, programmable electronic device to which IEC61508 is applied, its risks, namely, probability of failure (on demand) of a safety function is required to be precisely calculated. On the other hand, to continuously detect a safety available state of a safety function, it is necessary for the device to have high performance of diagnosing a safety/failure state thereof.

JP-A-6-290066 describes a technique using a duplex device to confirm health of a computer system. That is, in the duplex device, two computer systems are coupled via a communication bus with each other. In the computer systems including first and second computer systems, the first computer system writes check data in the second computer system at a particular address. The second computer system detects an event of update of the check data to determine normality or abnormality of the duplicate device on the basis of a result of the detection.

U.S. Pat. No. 6,779,128 B1 describes a technique of a control system for two computer modules in which the contents of memories of the computer modules are equalized and the memories are diagnosed between the two computer modules. Specifically, to copy the memory contents from one of the computer modules onto the other one thereof, a switch is disposed between a processor and the memory in each of the computer modules. The switches of the computer modules are coupled with each other using synchronizing signals. The processor of one of the computer modules reads its own memory contents and writes the contents in the memory of the other one of the computer modules using the switches and the synchronizing signals of the respective computer modules.

The computer used in the safety device aims that occurrence of an event in which failure cannot be detected by self-diagnosis to result in a state of dangerous failure is minimized to reduce probability of failure of the safety function to the maximum extent. However, from a point of view of self-diagnosis, the techniques of the prior art are attended with problems to achieve the object of the present invention.

That is, in the duplicate device of JP-A-6-290066, description has not been given of a self-diagnosis method of its own communication bus. Moreover, description has not been given of a method of identifying a position of the failure, for use at a failure. When the check data is not normally updated, it is impossible to determine whether this occurs due to abnormality of any computer system or due to abnormality of the communication bus. Therefore, when failure is assumed, it cannot be determined whether or not communication with other input/output devices, not shown, generally connected onto the communication bus is possible. As a result, to control the input/output devices at occurrence of abnormality, it is not possible to determine whether or not, for example, shutdown of a control system can be instructed.

In the control system of U.S. Pat. No. 6,779,128, although a memory device diagnosis method has been described, description has not been given of a method of diagnosing a diagnosis signal line and a signal line between the computer modules. When these signals lines cannot be diagnosed, there arises a problem similar to that of JP-A-6-290066.

### SUMMARY OF THE INVENTION

It is therefore an object of the present invention, which has been devised in consideration of the problems described above, to provide a machine management device and a communication line diagnosis device in which in a communication line included in a communication system to couple modules with each other, states of signal lines of the communication line are clearly determined to precisely diagnose the states of the signal lines at occurrence of failure.

According to an aspect of the present invention, there are disposed a communication line receiving part for receiving data transmitted from a communication line sending part onto a data communication line, from the data communication line and a diagnostic control part for processing a comparison result obtained by comparing the data transmitted from the communication line sending part onto the data communication line with the data received by the communication line receiving part.

According to the present invention, it is possible to make diagnosis for each signal line of the data communication line to detect failure due to, for example, a break and a short circuit thereof in a short period of time.

According to the present invention, it is possible to check a communication line included in a communication system to couple modules with each other to diagnose and to determine precise states of signal lines of the communication line.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of a first embodiment of a computer system according to the present invention.

FIG. 2 is a diagnosis operation flow of the first embodiment of a computer system according to the present invention.

FIG. 3 is a block diagram showing an example of a configuration of a communication line sending part according to the present invention.

FIG. 4 is a flowchart showing operation of the communication line sending part according to the present invention.

FIG. 5 is a flowchart showing operation of a communication line monitoring part according to the present invention.

FIG. 6A is a diagram showing an example of a configuration of a data communication line according to the present invention.

FIG. 6B is a diagram showing an example of operation signal waveforms on the data communication line according to the present invention.

FIG. 6C is a diagram showing an example of diagnosis signal waveforms on the data communication line according to the present invention.

FIG. 7 is a block diagram showing a configuration of a second embodiment of a computer system according to the present invention.

FIG. 8 is a block diagram showing a configuration of a third embodiment of a computer system according to the present invention.

FIG. 9 is a flowchart showing a diagnosis algorithm in a fourth embodiment according to the present invention.

### DESCRIPTION OF THE EMBODIMENTS

### Embodiment 1

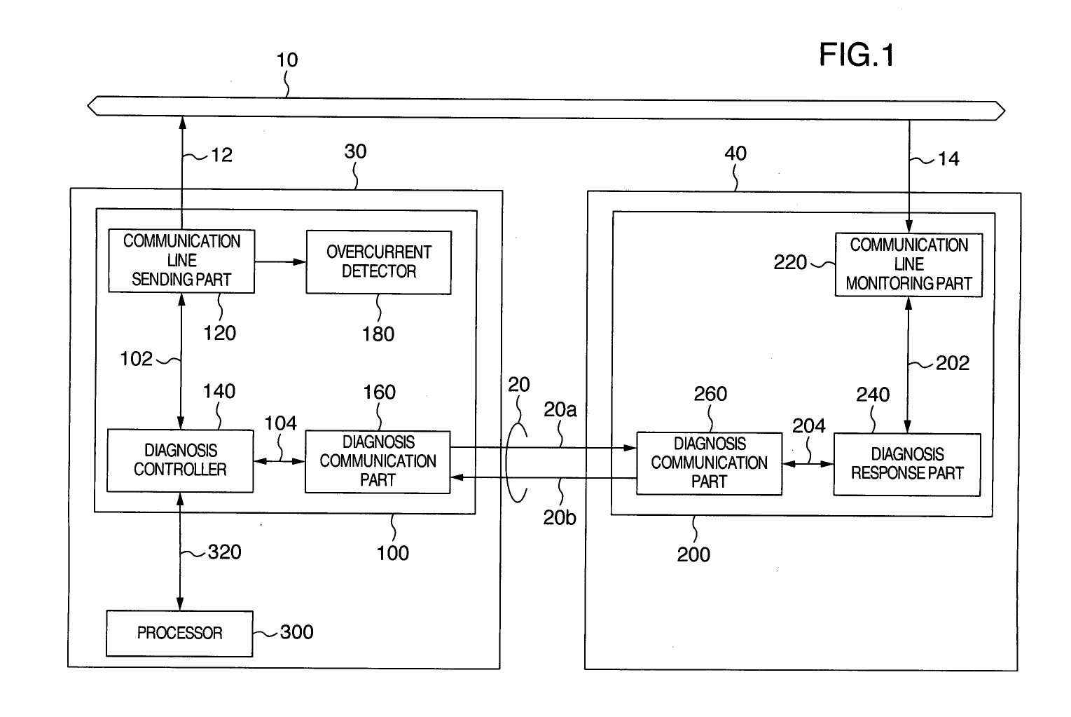

FIG. 1 shows a configuration of a first embodiment of a computer system according to the present invention. The computer system includes a diagnosis module 30, a monitoring module 40, a data communication line 10 to communicate data between the modules 30 and 40, and a diagnosis communication line 20 to communicate diagnosis information therebetween.

In a driving mode of signal lines of the communication lines, the signal lines are generally driven according to binary values represented by a high voltage and a low voltage. It is also possible to use various transmission methods known to those skilled in the art. That is, the signal lines may be driven using a plurality of voltages to transmit multi-level signals and information may be transmitted using a differential voltage by combining a plurality of signals with each other. The present invention is not particularly restricted by any of the methods and the configurations described above. For the data communication line 10 and the diagnosis communication line 20, there may be used a transmission path such as a parallel bus in which a plurality of signals are utilized in parallel with each other, a serial bus or channel in which a single ended or a differential signal is used, or a transmission line implemented by combining a parallel bus with a serial bus. However, the present invention is not particularly restricted by any of the transmission paths.

In the description below, “assert” indicates to drive a signal line having two driving modes to an enable state and “negate” indicates to drive the line to a disable state. For example, a signal of negative polarity is asserted to a low voltage and is negated to a high voltage.

In the description of the embodiment, the data communication bus 10 includes a binary, bidirectional parallel bus and the diagnosis communication line 20 includes two pairs of unidirectional serial channels. In the line 20, a serial channel used in a direction from the diagnosis module 30 to the monitoring module 40 is referred to as a reverse channel 20a and a serial channel used in a direction opposite to that of the reverse channel 20a is referred to as a forward channel 20b. However, the present invention is not restricted by these combinations as above. In the description of the embodiment, the system is a single master system in which only the diagnosis module 30 can initiate operation to access the data communication line 10.

The diagnosis module 30 includes a master diagnosis device 100, a processor 300, and a processor bus 320 connecting the device 100 and the processor 300 to each other. The master diagnosis device 100 includes a diagnosis controller 140, a diagnosis communication part 160, a communication line sending part 120 to drive the data communication line 10 via a data communication line stub 12, and an overcurrent detector 180. The diagnosis controller 140 controls, in response to an instruction from the processor 300, the sending part 120 using an output indication signal 102. The sending part 120 receives a bit pattern, which is to be sent to the data communication line 10, from the diagnosis controller 140. While controlling a state of the data communication line 10, the sending part 120 drives signal lines, not shown, of the line 10 according to the bit pattern. The diagnosis controller 140 controls the diagnosis communication part 160 and executes diagnosis processing by use of a response from the diagnosis communication part 160. The overcurrent detector 180 is disposed to detect an event that the communication line sending part 120 has consumed an excessive current, i.e., an overcurrent. The detector 180 includes an overcurrent detecting circuit to detect a current equal to or more than a predetermined value. When the detector 180 detects an overcurrent, it is desirable from a viewpoint of protection of the computer system to execute processing, for example, to protect the communication line sending part 120 and to shut down the communication system.

The monitoring module 140 includes a slave diagnosis device 200. The device 200 includes a diagnosis response part 240, a diagnosis communication part 260, and a communication monitoring part 220 to monitor the data communication line 10 via a data communication line stub 14. The diagnosis response part 240 receives a trigger from the diagnosis communication part 260, controls the monitoring part 220, and returns a response from the part 220 to the diagnosis communication part 260.

The diagnosis communication parts 160 and 260 communicate diagnosis information via the diagnosis communication line 20 (20a, 20b) with each other. A request from the diagnosis module 30 to the monitoring module 40 is sent via the reverse channel 20a. A response from the monitoring module 40 to the diagnosis module 30 is sent via the forward channel 20b. According to the present invention, the diagnosis communication line 20 can be implemented using known techniques such as RS232C, RS422, RS485, and Low Voltage Differential Signaling (LVDS). It is also possible to combine an Ethernet (registered trademark) cable with a hub. Particularly, if the diagnosis module 30 and the monitoring module 40 are beforehand associated with a communication device and a communication line such as a network, the additional cost can be favorably reduced by using the diagnosis communication part 160 or 260 and the diagnosis communication line 20 together with the existing network.

To lower the failure rate in the communication between the constituent components of the main and slave diagnosis devices 100 and 200, it is favorable that the constituent components are formed in one chip. However, the present invention is also applicable even when such configuration is technologically and/or financially difficult and one or more constituent components are disposed as separate elements outside the device 100 or 200. Therefore, while using the existing parts, the cost to implement the present invention can be reduced by developing only such required constituent components.

The diagnosis module 30 and the monitoring module 40 each generally include not only the processor 300 and the master diagnosis device 100 or the slave diagnosis device 200, but also a memory, not shown, and various input/output (I/O) devices, not shown. These devices are generally connected to each other using existing techniques known to those skilled in the art to thereby implement the computer functions. The known techniques include parallel buses such as a processor bus 320, a Peripheral Component Interconnect (PCI) bus, a Low Pin Count (LPC) bus, and an ISA bus as well as serial buses such as a PCI express and a Universal Serial Bus (USB). However, the present invention is not restricted by the these techniques.

For physical mounting positions of the diagnosis module 30 and the monitoring module 40, to achieve the object of the present invention, i.e., to precisely diagnose the data communication line 10, it is desirable to mount the modules 30 and 40 respectively at both ends of the data communication line 10. That is, all input/output modules, not shown, conducting communication via the line 10 are installed between the modules 30 and 40. When the line 10 is of a line of bus coupling type in which the input/output modules share the signal lines of the data communication line 10, a break on the line 10 can be assuredly detected by disposing the modules 30 and 40 respectively at both ends of the signal lines.

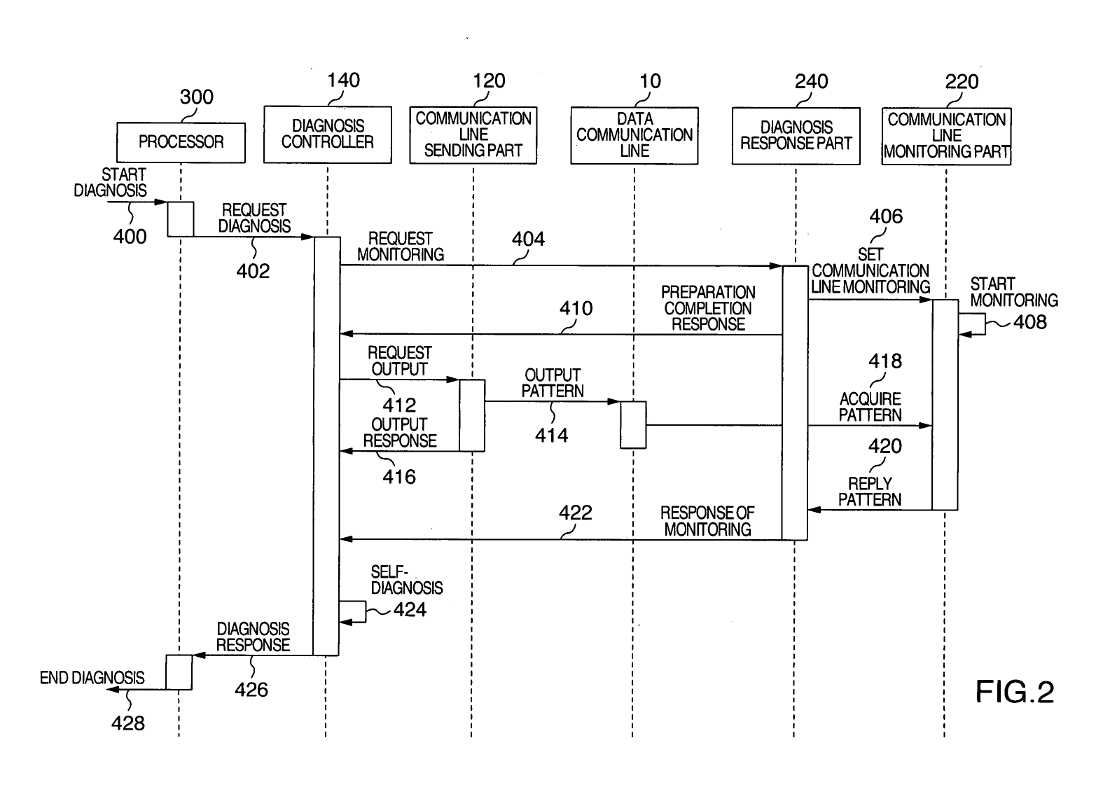

FIG. 2 shows a diagnosis operation flow in the first embodiment of a computer system according to the present invention. To diagnose the data communication line 10, the processor 300 receives a trigger (step 400). The trigger to start diagnosis includes a constant cycle interrupt by a timer, an instruction from a task, not shown, operating on the processor, or an interrupt from a device, not shown, existing in the diagnosis module 30. The processor 300 then issues a request to the diagnosis controller 140 to diagnose the data communication line 10 (step 402). After having received the request from the processor 300, the diagnosis controller 140 issues a request via the diagnosis communication part 160 and the reverse channel 20a to the diagnosis response part 240 to monitor the communication line 10 (step 404).

The diagnosis controller 140 may issue the monitoring request in the format suitable for the diagnosis communication part 160 to send information. When the part 160 is, for example, an Ethernet (registered trademark) sending/receiving controller, the diagnosis controller 140 may pass complete frame data to the diagnosis communication part 160, the data including an MAC address of a destination and an MAC address of a source in a first field thereof and message data of a monitoring request as its content. There may be used another method in which the diagnosis controller 140 sends only a message indicating a monitoring request to the diagnosis communication part 160. The part 160 adds necessary frame data items to the message to form complete frame data and then sends the data to the reverse channel 20a.

The diagnosis response part 240 receives the monitoring request, decodes the message contained in the request, and issues an instruction to the communication line monitoring part 220 to monitor the data communication line 10 (step 406). The part 220 starts monitoring (step 408). When preparation for the monitoring of the line 10 is completed, the diagnosis response part 240 replies a preparation completion message to the diagnosis controller 140 via the diagnosis communication part 260 and the forward channel 20b (step 410). The controller 140 receives the message and notifies to the communication line sending part 120 a bit pattern to be sent to the data communication line 10 (step 412). The part 120 receives and then sends the bit pattern to the line 10 (step 414) and returns a response to the diagnosis controller 140 (step 416).

The communication line monitoring part 220 monitoring the data communication line 10 receives the bit pattern sent to the line 10 (step 418) and returns the bit pattern to the diagnosis response part 240 (step 420). The part 240 receives the monitored bit pattern and then returns the bit pattern as a response via the diagnosis communication part 260 and the forward channel 20b to the diagnosis controller 140 (step 422). The relationship between the diagnosis response part 240 and the diagnosis communication part 260 is similar to that between the diagnosis controller 140 and the diagnosis communication part 160 described above. It is favorable that the response part 240 passes the information to the communication part 260 in a method suitable for the diagnosis communication part 260 to send the response of the monitored bit pattern to the forward channel 20b.

The diagnosis controller 140 receives the response of the monitored bit pattern to compare the bit pattern with the bit pattern indicated by the controller part 140 to the communication line sending part 120 in step 412 (step 424) and then notifies a result of the comparison to the processor 300 (step 426). To notify the result to the processor 300, the controller 140 may use a method in which the processor 300 conducts a polling operation for registers of the diagnosis controller 140 and awaits a response of the monitoring. Or, there may be used a method in which an interrupt event is notified from the diagnosis controller 140 to the processor 300 using an interrupt signal line, not shown, included in the processor bus 320. Finally, the processor 300 receives the result of the comparison to execute processing on the basis of the result and then terminates the diagnosis flow (step 428).

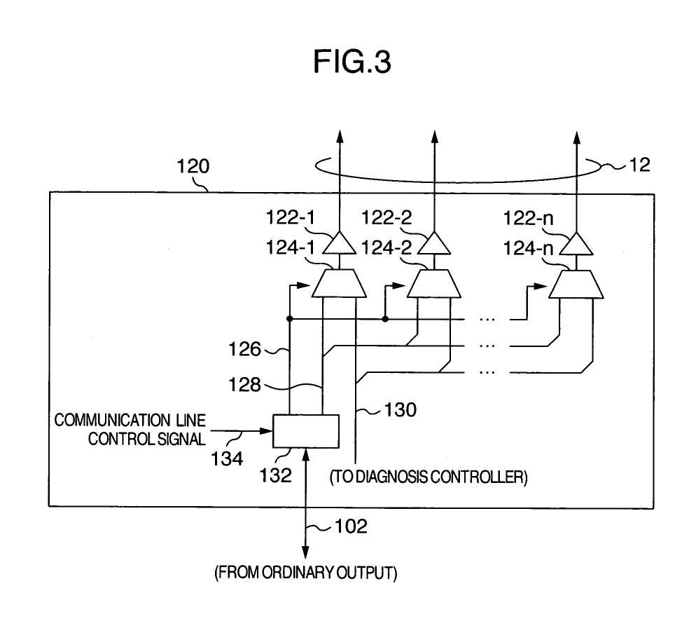

FIG. 3 shows a precise configuration of the communication line sending part 120 in the first embodiment according to the present invention. The part 120 includes output buffers 122-1 to 122-n, output selectors 124-1 to 124-n, an output selection signal 126, a diagnosis output signal 128, an ordinary output signal 130, a diagnosis output controller 132, and a communication control signal 134 (n is the number of output signals). The output buffers 122-1 to 122-n are disposed to output signals, which are outputted respectively from the output selectors 124-1 to 124-n, via the data communication line stub 12 to the data communication line 10. The output selectors 124-1 to 124-n are arranged to output therefrom either one of the input signals, i.e., the diagnosis output signal 128 or the ordinary output signal 130 selected by the output selection signal 126. The ordinary output signal 130 is an ordinary output signal which the master diagnosis device 100 delivers to the data communication line 10 for a purpose other than diagnosis. The communication control signal 134 is a signal including signals to control the state of the data communication line 10.

The diagnosis output controller 132 generates an output selection signal 126 and a diagnosis output signal 128 using the communication line control signal 134 and the output indication signal 102. The controller 132 includes a state machine to sequentially select all or part of the signals of the bit pattern contained in the output indication signal 102 and outputs the selected signals of the bit pattern to the data communication line 10 while modulating the signals according to necessity.

Although the data communication line 10 includes a plurality of signal lines (n in number) in the drawings, the present invention is applicable also when n=1, that is, for a serial bus. In such case, for example, the diagnosis output controller 132 conducts a control operation such that a parallel bit pattern received from the diagnosis controller 140 is sequentially sent in a serial fashion to the data communication line 10.

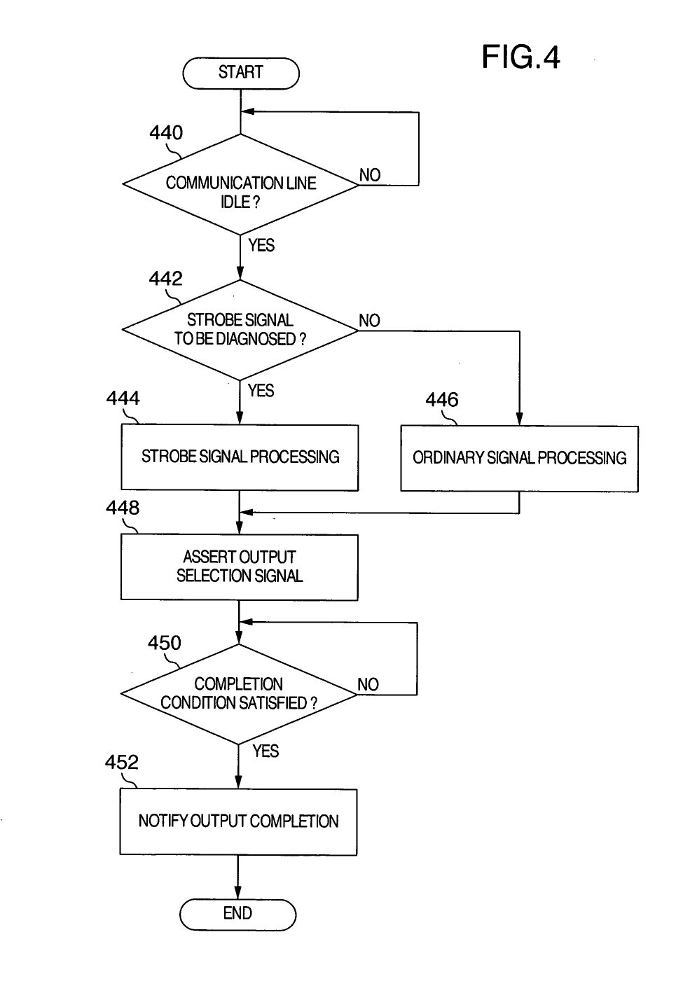

FIG. 4 shows a flow of operation of the diagnosis output controller 132. The controller 132 executes the operation flow shown in FIG. 4 in response to a diagnosis start instruction from the diagnosis controller 140.

The diagnosis output controller 132 first makes a check according to the communication line control signal 134 to determine whether or not the state of the data communication line 10 is idle in which no module is using the line 10 (step 440). Although the embodiment includes only one master module, i.e., the diagnosis module 30 for the data communication line 10, the operation flow is effective or applicable even if any masters are connected to the line 10. The diagnosis output controller 132 stays in a wait state until the data communication line 10 enters an idle state. When the line 10 becomes idle, the controller 132 makes a check to determine whether or not a signal to be diagnosed is a strobe signal of the data communication line 10 (step 442). If the signal is the strobe signal, the controller 132 executes processing for the strobe signal (step 444). Otherwise, the controller 132 executes processing for an ordinary signal (step 446). Finally, the diagnosis output controller 132 asserts the output selection signal 126 and sends a diagnosis output signal 128 to the data communication line 10 (step 448). The controller 132 then waits for an event in which an output completion condition is satisfied (step 450). When the condition is satisfied, the controller 132 notifies the output completion to the diagnosis controller 140 (step 452) and then terminates the diagnosis output processing.

As a condition to continue the signal drive in step 450, there can be considered, for example, an operation to continue the signal drive for a predetermined period of time by use of a timer, not shown and an operation to continue the signal drive until signal line processing required in the state transition specification, not shown, of the data communication line 10 is finished, for example, until particular signal line sequential control is finished.

An object of the present invention is to discriminate a strobe signal of the data communication line 10 from the other signals to diagnose the signals other than the strobe signal without driving the strobe signal. Another object of the present invention to diagnose the strobe signal itself by devising a driving method of the strobe signal.

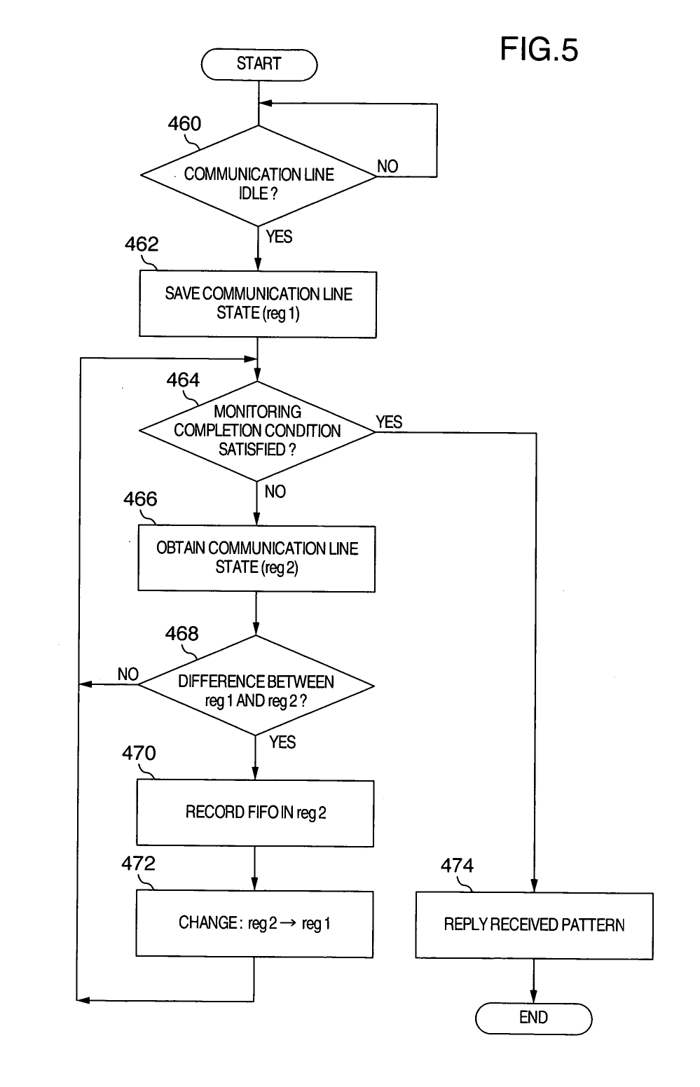

FIG. 5 shows an operation flow of the communication line monitoring part 220 in the first embodiment according to the present invention. The part 220 is arranged to appropriately recognize behavior of a signal driven on the data communication line 10 to notify the signal to the diagnosis response part 240. The flow of FIG. 5 shows operation of the communication line monitoring part 220 having received a communication line monitoring setting indication from the diagnosis response part 240.

The monitoring part 220 enters and stays in a wait state until the data communication line 10 becomes idle (step 460). If the line 10 is idle in advance, the part 220 saves a signal line state of the line 10 at this point of time (step 462). It is assumed in this embodiment that registers, i.e., reg 1 and reg 2 having width to save the signal line state of the line 10 are prepared. The state is saved in reg 1 for convenience of description. The part 220 then makes a check to determine whether or not a monitoring completion condition has been satisfied (step 464).

The monitoring completion condition is, for example, an event in which a period of time lapsed after the initiation of the flow is measured by a timer, not shown, and the period of time exceeds a predetermined period of time or an event in which the number of signal changes in the data communication line 10 exceeds a predetermined value.

If the condition is not satisfied in step 464, the communication line monitoring part 220 obtains the state of the data communication line 10 to store the state in the register reg 2 (step 466). The part 220 checks difference between the state and that of the line 10 beforehand stored (step 468). Specifically, the communication line monitoring part 220 conducts an Exclusive OR operation for the associated bits respectively of reg 1 and reg 2. If this results in non-zero, the part 220 assumes presence of the difference. On the other hand, if the communication line monitoring part 220 assumes absence of the difference, control goes again to the first step (step 464) of the loop. In the case in which the presence of the difference is assumed, the part 220 records the value of the current register reg 2 in a temporal memory, for example, a First In First Out (FIFO) memory (step 470). Thereafter, the communication line monitoring part 220 updates the value of the register reg 1 to the value of the register reg 2 and then branches to step 464, i.e., the first step of the loop (step 472).

When the monitoring completion condition is satisfied in step 464, the communication line monitoring part 220 obtains the received pattern stored in step 470 from the temporal memory, for example, the FIFO memory and returns the pattern as a response to the diagnosis response part 240 (step 474) to thereby terminate the processing flow.

Through the processing flow, the communication line monitoring part 220 can notify only the state changed on the data communication line 10 to the diagnosis response part 240. Therefore, the capacity of the temporal memory can be reduced in the communication line monitoring part 220 to the maximum extent, and hence the slave diagnosis device 200 can be configured at a low cost.

To improve precision or accuracy of the diagnosis, it is also possible to use a method in which the registers reg 1 and reg 2 are expanded in width to store, in addition to the state of the data communication line 10, the value of a timer, not shown, the value indicating a point of time at which the state is obtained. The time of acquisition of the state of the line 10 is known from the timer value, and hence whether of not the signal line has changed at expected timing can be determined. According to the procedure, it is possible to detect failure in an output buffer in which, for example, although there is detected a level change on an associated signal line, an excessively long period of time is required to drive the signal line.

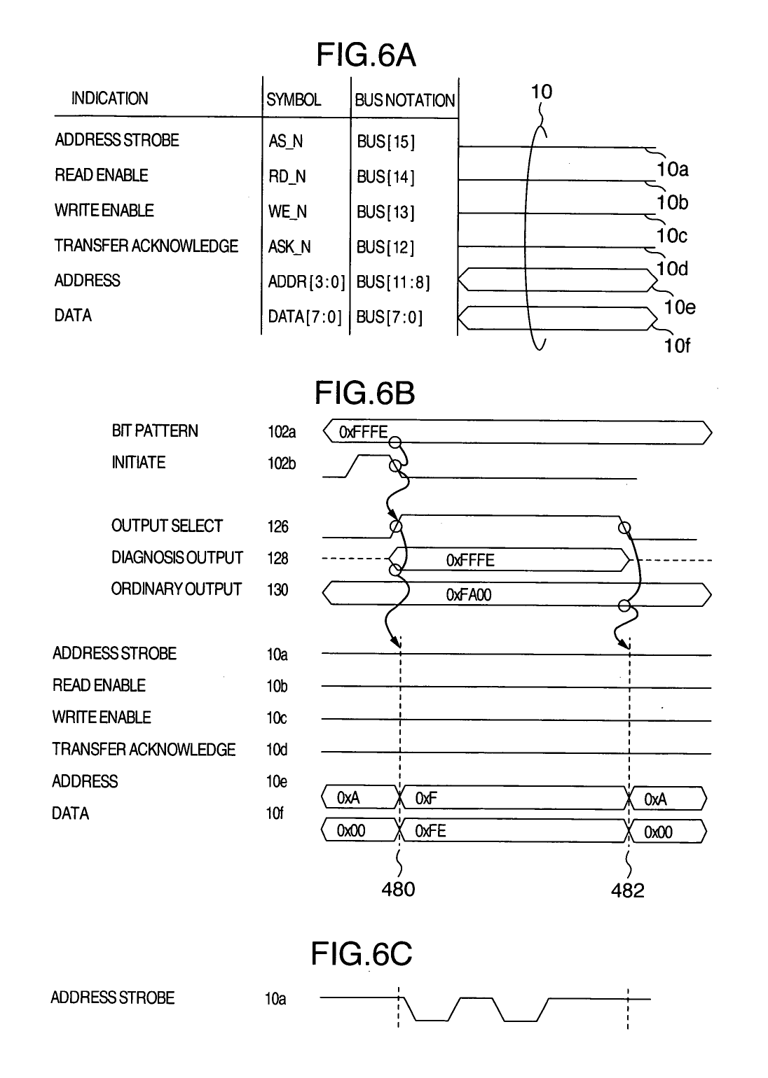

FIG. 6A shows an example of a configuration of the data communication line 10 and an example of operation of the communication line sending part 120 and the communication line monitoring part 220 in the first embodiment according to the present invention. In the signal line symbols of FIG. 6A, “_N” at an end of an associated signal indicates that the symbol has negative polarity. The data communication line 10 includes signal lines of an address strobe 10a, a read enable 10b, a write enable 10c, a transfer acknowledge 10d, an address 10e, and data 10f. In the example, the line 10 includes 16 signal lines, which are represented using 16 signal lines associated with 16 bits. The data communication line 10 can be represented as BUS[15:0] in bus notation, and the correspondence between the signal line notation and the bus notation is as shown in FIG. 6A. In the notation, “[15:0]” indicates 16 signal lines.

In the transmission procedure of the data communication line 10 in the embodiment, it is assumed that “assert” of the address strobe 10a indicates transfer initiation. That is, according to an aspect of the transmission procedure, only when the address strobe 10a is asserted, transfer operation takes place on the line 10. Using the aspect, the embodiment diagnoses signals other than the address strobe 10a. Also in another transmission procedure on the data communication line 10, the present invention is applicable by replacing the address strobe of the embodiment by a signal indicating transfer initiation described above.

Description will now be given of the data communication line 10 of FIG. 6A by referring to the operation flow of the communication line sending part 120 shown in FIG. 6B. The output indication signal 120 from the diagnosis controller 140 includes a bit pattern 102a to be outputted and a diagnosis start signal 102b. Description will now be given of operation when the bit pattern 102a includes 0×FFFE in which 0× is a prefix indicating hexadecimal notation. When a pulse of the diagnosis start signal 102b is detected, the diagnosis output controller 132 determines a state of the data communication line 10 according to the flow of FIG. 4. When the line 10 is in an idle state in which no module is using the line 10, the controller 132 makes a check to determine whether or not the signal pattern for the drive is an address strobe 10a which is a bus drive signal. In the case of FIG. 6B, the bit pattern 102a indicates other than “assert” of the address strobe 10a, the controller 132 passes the pattern 102a as the diagnosis output signal 128. Thereafter, to output the signal 128 to the line 10, the controller 132 drives the output selection signal 126 to output the bit pattern 102a to the various control signals 10a to 10d as well as the address 10e and the data 10f (point of time 480). Up to this point of time, data designated by the ordinary output signal 130 has been outputted to the data communication line 10, i.e., 0×A to the address 10e and 0×00 to the data 10f. The data items are changed by the operation described above. That is, the data contents designated by the diagnosis output signal 128 are outputted, namely, 0×F to the address 10e and 0×FE to the data 10f. Thereafter, the controller 132 keeps the state until a predetermined condition is satisfied. After the condition is satisfied, the controller 132 negates the output selection signal 126 and changes the data contents to be outputted to the data communication line 10 to thereby terminate the diagnosis output operation.

Description will next be given of the operation of the diagnosis output controller 132 when the bit pattern 102a includes 0×7FFF, that is, when “assert the address strobe 10a” is instructed. The controller 132 executes processing for the strobe signal in step 444 of the flow shown in FIG. 4. There can be employed an operation procedure using a pulse drive operation in which the address strobe 10a is driven in a short period of time as indicated in FIG. 6C. This procedure does not use a continuous asserting operation to prevent the other input/output modules, not shown, connected to the data communication line 10 from sending a wrong response.

In this operation procedure, it is required for an address strobe input circuit of each of the other input/output modules connected to the line 10 to operate as below. The address strobe input circuit does not regard a short-period pulse as the address strobe. There may be used, for example, a method in which an integrating circuit is mounted in the address strobe input section of the input/output module such that the module reacts upon only “assertion for a period of time equal to or more than a predetermined period of time”. Also, there may be used a method in which the address strobe input section of the input/output module acquires the strobe according to a predetermined sampling period to react upon only when an effective value is sequentially obtained. In the operation, it is required that the pulse width of the pulse from the diagnosis output controller 132 is sufficiently less than the sampling period of each input/output module.

The method to drive the signal line by pulses as shown in FIG. 6C is efficiently used also when a plurality of signal lines are required to be asserted to prevent influence upon a signal line to be diagnosed from the other signal lines. That is, when the signal line to be diagnosed is short-circuited to a signal line simultaneously asserted, the diagnosis cannot be conducted only by use of an output level of each signal line. In this situation, the signal line to be diagnosed is driven by pulses for discrimination.

There may occur an event in which when a signal line to be diagnosed is short-circuited to another signal line, the output drivers of the short-circuited signal lines drive outputs of mutually opposite polarities. If the output drivers are output drivers configured using, for example, the complementary Metal Oxide Semiconductor (CMOS) technology, there occurs a phenomenon called latch-up in which an overcurrent flows between MOS transistors due to a short circuit. In this situation, the overcurrent detector 180 detects occurrence of the overcurrent. It is desirable in this case that the detector 180 notifies an alarm message to the computer system such that the computer system shuts down itself completely.

As above, according to the embodiment, all signals on the data communication line 10 can be outputted in a desired pattern for diagnosis. When the monitoring module 40 monitors the output signals on the line 10 and sends a result of the monitoring operation to the diagnosis module 30, the module 30 can determine a break and/or a short circuit of any signal line of the data communication line 10.

### Embodiment 2

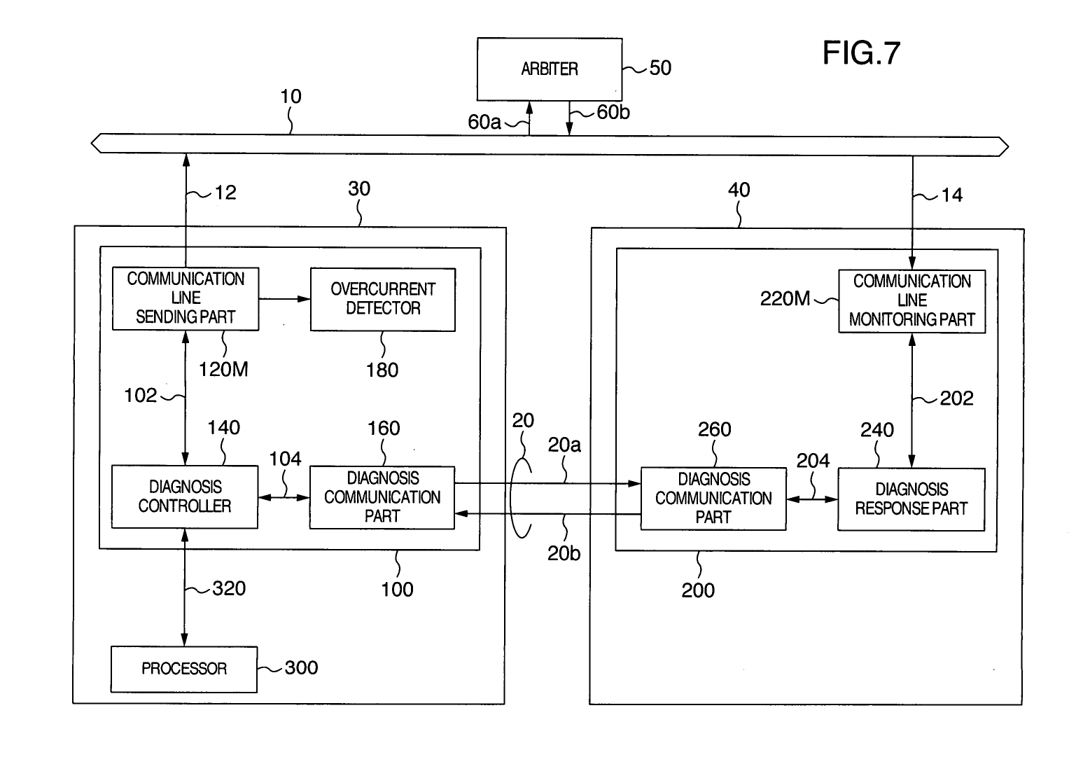

FIG. 7 shows a configuration of a second embodiment of a computer system according to the present invention. The computer system of the embodiment includes a plurality of master modules which access the data communication line 10.

The computer system includes a diagnosis module 30, a monitoring module 40, a data communication line 10 to communicate data between the modules 30 and 40, a diagnosis communication line 20 to communicate diagnosis information between the modules 30 and 40, and an arbiter 50 to control assignment of the access or use right to access the data communication line 10. In FIG. 7, the functional sections assigned with the same reference numerals as those of the first embodiment have the same functions unless otherwise noticed. As compared with the first embodiment, the second embodiment has an aspect that the system additionally includes the arbiter 50 and an aspect that a communication line sending part 120M and a communication line monitoring part 220M cope with operation of a plurality of master modules.

When the data communication line 10 is a line of a bus coupling type in which a plurality of devices share the signal lines of the line 10, for example, a type of a bus such as a Peripheral Computer Interconnect bus or a Static Random Access Memory (SRAM) bus, the arbiter 50 generally controls assignment of the right to use the bus. Before using the data communication line 10, any master module desiring to use the line 10 notifies a bus request 60a to the arbiter 50 of the line 10 to obtain permission to use the line 10. When a plurality of master modules issue such request, any master module to which the arbiter 50 gives bus grant 60b starts outputting signals to the line 10. As compared with the communication line sending part 120 of the first embodiment, the communication line sending part 120M additionally includes a function to output the bus request 60a and to input the bus grant 60b.

The operation flow of the communication line sending part 120M is almost the same as that shown in FIG. 4 excepting the following point. That is, there is required an operation in which immediately before the operation flow of FIG. 4 is started, the bus request 60a is issued to the arbiter 50 or an associated signal line is asserted and then the processing enters and stays in a wait state until the bus grant 60b is obtained. In general, the request 60a is continuously issued or the associated signal line is continuously asserted until the access to the data communication line 10 is not required. Once the communication line sending part 120M obtains the bus grant 60b, of FIG. 4 is started.

As compared with the communication line sending part 120 of the first embodiment, the communication line sending part 220M additionally includes a function to input the input the bus grant 60b.

The operation flow of the communication line monitoring part 220M is almost the same as that shown in FIG. 5 excepting the following point. That is, there is required an operation in which immediately before the operation flow of FIG. 5 is started, the part 220M enters and stays in a wait state until the bus grant 60b of the data communication line 10 is given to the communication line sending part 120M. Once the communication line monitoring part 220M confirms an event that the bus grant 60b has been given to the sending part 120M, the flow of FIG. 5 is similarly executed.

Through the operation in the above configuration, even a computer system in which a plurality of master modules access the data communication line 10, all signals on the line 10 can be outputted in a desired pattern for diagnosis in a way similar to that of the first embodiment. When the monitoring module 40 monitors the output signals onto the line 10 and sends a result of the monitoring operation to the diagnosis module 30, the module 30 can determine a break and/or a short circuit of any signal line of the data communication line 10. Even when the line 10 is being used by another input/output module, not shown, the diagnosis module 30 can issue a monitoring request of the data communication line 10 shown in step 404 at desired timing. Therefore, the monitoring module 40 can correctly monitor the line 10. According to the present invention, the diagnosis module 30 can freely start diagnosis and can flexibly make a diagnosis schedule.

### Embodiment 3

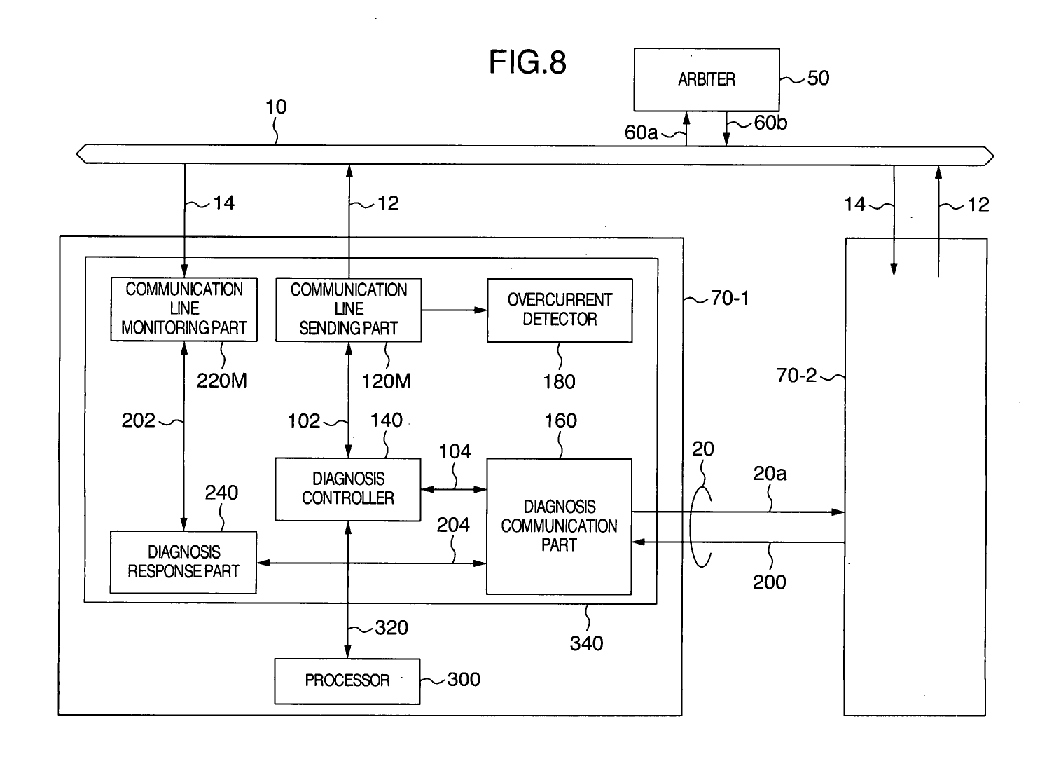

FIG. 8 shows a configuration of a third embodiment of a computer system according to the present invention. In the embodiment, the computer system includes a plurality of diagnosis modules 70. The computer system of FIG. 8 includes two diagnosis modules 70, a data communication line 10 to communicate data between the modules 70, a diagnosis communication line 20 to communicate diagnosis information between the modules 70, and an arbiter 50 to control assignment of the access right of the data communication line 10. In FIG. 8, the functional sections assigned with the same reference numerals as those of the first and second embodiments have the same functions unless otherwise noticed.

Although FIG. 8 shows two diagnosis modules 70-1 and 70-2 for convenience of description, the computer system of the present invention is not restricted by the embodiment. That is, the number of such diagnosis modules is not limited to two. When the diagnosis communication line 20 is configured to communicate data between a plurality of diagnosis modules via, for example, a network hub, it is possible to conduct diagnosis between a plurality of diagnosis modules.

When compared with the first and second embodiments, the third embodiment has an aspect that a diagnosis device 340 comprehensively includes the diagnosis function implemented in two partitions including a function of the diagnosis module 30 and a function of the monitoring module 40. Moreover, there is prepared a diagnosis module in which the diagnosis device 360 installed, and a plurality of diagnosis modules are installed to cooperatively perform operation so that the diagnosis modules 70 mutually conduct self-diagnosis.

The diagnosis operation flow of the computer system in the third embodiment is substantially equal to that shown in FIG. 2. That is, when a first diagnosis module, e.g., the module 70-1 sends a monitoring request via the diagnosis communication line 20 to a second diagnosis module, e.g., the module 70-2, the communication line monitoring part 220M of the diagnosis module 70-2 monitors the line 10 and sends a result of the monitoring operation to the diagnosis module 70-1. Therefore, the diagnosis module 70-1 can diagnose the signal outputted by itself, i.e., the module 70-1 onto the data communication line 10. The operation is possible also when the diagnosis modules 70-1 and 70-2 are replaced by each other, and hence the diagnosis module 70-2 can similarly diagnose the signal lines of the data communication line 10.

According to the embodiment described above, each of the diagnosis modules can output all signals on the data signal line 10 in a desired pattern for diagnosis. Resultantly, it is possible to determine a break and/or a short circuit of any signal line. Since the modules are substantially equal to each other, the number of design steps of the modules can be reduced, and hence the cost required to develop the modules can also be minimized.

### Embodiment 4

Description will now be given of a fourth embodiment of a computer system according to the present invention. The computer system of the fourth embodiment is almost the same as that shown in FIG. 8 excepting the diagnosis communication part 160. In the embodiment, the part 160 additionally includes an internal loop-back function. The embodiment has an aspect that the diagnosis controller 140 receives two or more responses of the monitoring operation from the diagnosis communication part 160 to compare a signal outputted by itself, i.e., the diagnosis controller 140 with the received responses.

Referring to FIG. 2, description will be given of a diagnosis operation flow in the computer system of the fourth embodiment. In the description, it is assumed that the processor 300 of the diagnosis module 70-1 starts diagnosis. In the embodiment, the diagnosis communication part 160 loops the monitoring request of step 404 of FIG. 2 back to the diagnosis module 70-1 to pass the diagnosis request also to the diagnosis response part 240 in the diagnosis module 70-1. Thereafter, not only the communicating diagnosis module 70-2, but also the diagnosis response part 240 and the communication line monitoring part 220M of the communicating diagnosis module 70-1 monitor the data communication line 10. As a result, the diagnosis module 70-1 receives the monitoring response of step 422 from the diagnosis module 70-2 and from the diagnosis response part 240 of the diagnosis module 70-1.

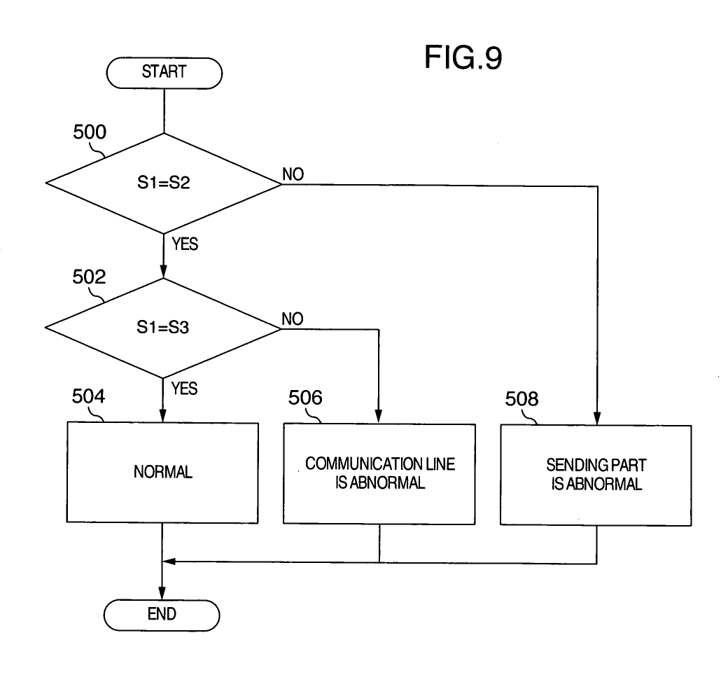

Thereafter, the signal line state is diagnosed in step 424 for self-diagnosis using a diagnosis algorithm shown in FIG. 9. It is assumed that a bit pattern used as an output indication issued to the data communication line 10 is S1, a bit pattern received by the own communication line monitoring part 220M (of the diagnosis module 70-1) is S2, and a bit pattern received by the communication line monitoring part 220M of the diagnosis module 70-2 is S3.

First, S1 is compared with S2 (step 500). If S1 is other than S2, abnormality of the communication line sending part 120M is assumed (step 508) and the diagnosis is terminated. The abnormality of the sending part 120M may be caused by failure of an output buffer (a signal cannot be driven or a wrong operation takes place) and a short circuit of an signal line. If S1 is equal to S2, S1 is further compared with S3 (step 502). If S1 is other than S3, abnormality of the data communication line 10 is assumed (step 506) and the diagnosis is terminated. The abnormality of the line 10 may be caused by a break or a short circuit of a signal line. If S1 is equal to S3, the line 10 is regarded as normal (step 504) and the diagnosis is terminated.

According to the embodiment described above, the output signal driven by the communication line sending part 120M can be monitored by the communication line monitoring part 220M of the diagnosis device 340 including the sending part 120M. All signals on the data communication line 10 can be outputted in a desired pattern for diagnosis. As a result, a break and a short circuit of any signal line as well as failure in the sending part (a signal cannot be driven or a wrong operation takes place) of the diagnosis module 70 can be determined, the sending part outputting signals to the data communication line 10.

When a diagnosis module detects failure unique thereto as a result of the self-diagnosis, it is possible to continue stable control by disabling the module so that control is not affected by the module.

According to the embodiment, during the mutual diagnosis between a first diagnosis module and a second diagnosis module, even when the second diagnosis module cannot send a response to the first diagnosis module due to failure or the like, the first diagnosis module can conduct self-diagnosis by itself. For example, the diagnosis module drives the data communication line 10 to monitor the line 10 by itself. In this situation, it is difficult to diagnose a break of the data communication line 10. However, an event in which a bus is in an undefined state beyond a predetermined state range due to, for example, failure of a pull-up resistor or a break can be detected by using the bus state save register including a timer value as described above. Since each diagnosis module can conduct self-diagnosis as a single unit, it is possible to continue more stable operation in this case as compared with a case in which the self-diagnosis is not possible.

In the embodiments, it is assumed that the processor 300 issues the trigger to start diagnosis (step 400 of FIG. 2) and the diagnosis request (step 402 of FIG. 2). However, the present invention is not restricted by the embodiments. For example, a diagnosis cyclic timer, not shown, and a pattern generating function, not shown, are prepared in the diagnosis controller 140. The diagnosis cyclic timer generates the trigger to start diagnosis (corresponding to step 400 of FIG. 2). The pattern generating function generates a bit pattern for diagnosis (corresponding to step 402 of FIG. 2). The pattern generating function may employ a method in which the function sequentially selects a bit beginning at a lower-most bit each time diagnosis is initiated to sequentially set a value to the bit.

Although the result of self-diagnosis can be notified as a response to the processor 300 in any case (step 426 of FIG. 2), it is also possible that the result is not sent to the processor 300. That is, if the diagnosis controller 140 does not detect abnormality as a result of the diagnosis, control goes to a subsequent diagnosis without notifying the result to the processor 300. Only when the abnormality is detected, the result is reported to the processor 300.

As described above, there can be configured a diagnosis device capable of minimizing intervention of the processor. Therefore, it is possible to implement a diagnosis device which assuredly carries out the diagnosis irrespectively of the processor load.

According to the embodiment, each signal line of the data communication line can be diagnosed, and hence failure of the signal line due to a break and/or a short circuit can be detected in a short period of time.

The present invention is also applicable to a computer system including a plurality of master modules to conduct the diagnosis irrespectively of the state of the processor load.

Moreover, according to the embodiment, for example, when a diagnosis device is mounted in the diagnosis module and a plurality of such diagnosis modules substantially equal to each other are disposed on the data communication line, it is possible to conduct mutual diagnosis of the data communication line.

According to the embodiment, even when abnormality is detected as a result of the self-diagnosis, it is possible to determine a position of occurrence of and a state of the abnormality.

In the embodiment, a communication line such as an existing network device can be used as a diagnosis communication line. Therefore, the self-diagnosis function can be implemented in a computer system at a trifle additional cost.

It should be further understood by those skilled in the art that although the foregoing description has been made on embodiments of the invention, the invention is not limited thereto and various changes and modifications may be made without departing from the spirit of the invention and the scope of the appended claims.

1. A machine management device, comprising:
a communication line receiving part for receiving data sent onto a data communication line from a communication line sending part, from the data communication line; and
a diagnosis control part for processing a comparison result of comparison conducted between the data sent from the communication line sending part onto the data communication line with the data received by the communication line receiving part.

2. A machine management device, comprising:
a communication line sending part for sending data onto a data communication line;
a communication line receiving part for receiving the data sent onto the data communication line from the communication line sending part, from the data communication line; and
a diagnosis control part for processing a comparison result of comparison conducted between the data sent from the communication line sending part onto the data communication line with the data received by the communication line receiving part.

3. A machine management device according to claim 2, comprising:
a plurality of units of the communication line sending part; and
an arbiter for sending to the communication line sending part a granting signal granting the communication line sending part use of the data communication line, wherein
one of the communication line sending parts granted to use the data communication line by the granting signal sent from the arbiter sends data onto the data communication line.

4. A machine management device, comprising:
a first diagnosis device comprising:
a first communication line sending part for sending data onto a data communication line;
a first communication line receiving part for receiving the data sent onto the data communication line, from the data communication line; and
a first diagnosis control part for producing a comparison result of comparison conducted between the data sent from the first communication line sending part onto the data communication line with the data received by first the communication line receiving part; and
a second diagnosis device comprising:
a second communication line sending part for sending data onto the data communication line;
a second communication line receiving part for receiving the data sent from the second communication line sending part the onto the data communication line, from the data communication line; and
a second diagnosis control part for producing a comparison result of comparison conducted between the data sent from the second communication line sending part onto said data communication line with the data received by the second communication line receiving part, wherein
the second communication line receiving part receives the data sent from the first communication line sending part onto said data communication line, from the data communication line;
the second diagnosis device includes a second diagnosis communication part for sending to the first diagnosis control part the data received by the second communication line receiving part; and
the first diagnosis control part processes a comparison result of comparison conducted between the data sent from the second diagnosis sending part with the data sent from the first communication line sending part onto the data communication line.

5. A machine management device according to claim 4, wherein the first diagnosis control part includes a processing part for processing, when the data sent from the first communication line sending part onto the data communication line is substantially equal to the data received by the first communication line receiving part, a comparison result of comparison conducted between the data sent from the second diagnosis sending part with the data sent from the first communication line sending part onto the data communication line.

6. A communication line diagnosis device comprising:
a communication line sending part for sending data onto a data communication line;
a communication line receiving part for receiving the data sent onto the data communication line from the communication line sending part, from the data communication line; and
a diagnosis control part for processing a comparison result of comparison conducted between the data sent from the communication line sending part onto the data communication line with the data received by the communication line receiving part.

7. A communication line diagnosis device according to claim 6, comprising:
a plurality of units of the communication line sending part; and
an arbiter for sending to the communication line sending part a granting signal granting the communication line sending part use of the data communication line, wherein
one of the communication line sending parts granted to use the data communication line by the granting signal sent from the arbiter sends data onto the data communication line.

8. A communication line diagnosis device, comprising:
a first diagnosis device comprising:
a first communication line sending part for sending data onto a data communication line;
a first communication line receiving part for receiving the data sent onto the data communication line, from the data communication line; and
a first diagnosis control part for producing a comparison result of comparison conducted between the data sent from the first communication line sending part onto the data communication line with the data received by first the communication line receiving part; and
a second diagnosis device comprising:
a second communication line sending part for sending data onto the data communication line;
a second communication line receiving part for receiving the data sent from the second communication line sending part the onto the data communication line, from the data communication line; and
a second diagnosis control part for producing a comparison result of comparison conducted between the data sent from the second communication line sending part onto the data communication line with the data received by the second communication line receiving part, wherein
the second communication line receiving part receives the data sent from the first communication line sending part onto the data communication line, from the data communication line;
the second diagnosis device includes a second diagnosis communication part for sending to the first diagnosis control part the data received by the second communication line receiving part; and
the first diagnosis control part processes a comparison result of comparison conducted between the data sent from the second diagnosis sending part with the data sent from the first communication line sending part onto the data communication line.

9. A communication line diagnosis device according to claim 8, wherein the first diagnosis control part includes a processing part for processing, when the data sent from the first communication line sending part onto the data communication line is substantially equal to the data received by the first communication line receiving part, a comparison result of comparison conducted between the data sent from the second diagnosis sending part with the data sent from the first communication line sending part onto the data communication line.

10. A machine management method, comprising:
a communication line sending step of sending data by a communication line sending part onto a data communication line;
a communication line receiving step of receiving the data sent by the communication line sending step onto the data communication line, by a communication line receiving part from the data communication line;
a diagnosis control step of processing a comparison result of comparison conducted between the data sent by the communication line sending step onto the data communication line with the data received by the communication line receiving part; and
a display step of displaying a status of a machine according to the comparison result.

11. A machine management method according to claim 10, further comprising a step of disposing a plurality of units of the communication line sending part, wherein
the communication line sending step further includes a step of sending data to the communication line by one of the communication line sending parts granted to use the data communication line by a granting signal sent from an arbiter.
